(19) United States
(12) Patent Application Publication
(10) Pub. No.: US 2018/0033124 A1
(43) Pub. Date: Feb. 1, 2018

(54) METHOD AND APPARATUS FOR RADIOMETRIC CALIBRATION AND MOSAICKING OF AERIAL IMAGES

(71) Applicant: The Texas A&M University System, College Station, TX (US)

(72) Inventors: John A. THOMASSON, Hearne, TX (US); Yeyin SHI, Lincoln, NE (US)

(21) Appl. No.: 15/661,525

(22) Filed: Jul. 27, 2017

Related U.S. Application Data
(60) Provisional application No. 62/368,014, filed on Jul. 28, 2016.

(51) Int. Cl. G06T 5/00; H04N 17/00; B64D 47/08; G06T 5/50; G06K 9/52; B64C 39/02; G01S 19/26; G06T 3/40

(52) U.S. Cl. CPC G06T 5/008; G01S 19/26; H04N 17/002; G06T 3/4038; G06T 5/50; G06K 9/52; B64C 39/024; B64D 47/08; G06T 2207/10036; G06T 2207/20208; G06T 2207/30188; B64C 2201/127; B64C 2201/123

(57) ABSTRACT

The present invention relates to a system for performing radiometric calibration of mosaicking of images. The system includes a calibration reference positioned about an area to be imaged. A sensor is disposed on an aerial vehicle in flight over the area to be imaged. A processor is in communication with the sensor. A plurality of images are obtained by the sensor and are radiometrically calibrated and mosaicked by the processor regardless of whether a calibration reference is visible in an individual image of the plurality of images.

### CROSS-REFERENCE TO RELATED APPLICATIONS

This application claims priority to, and incorporates by reference the entire disclosure of, U.S. Provisional Patent Application No. 62/368,014 filed on Jul. 28, 2016.

### BACKGROUND

### Field of Invention

The present application relates generally to the radiometric calibration and mosaicking of images obtained by aerial vehicles and more particularly, but not by way of limitation, to methods and apparatuses for radiometric calibration and mosaicking utilizing objects of known reflectance positioned around an area to be imaged.

### History of the Related Art

Remote sensing finds use in a wide variety of applications. In, for example, agricultural applications, remote sensing can be utilized to obtain measurements of various parameters that provide indications of crop health. Such remote-sensing applications provide effective analysis of agricultural fields that can measure several hundred acres or more. Such remote sensing is typically accomplished with the use of fixed or rotary-wing aircraft. Typically, an aircraft at an altitude of, for example ten thousand to twenty thousand feet can effectively capture an entire agricultural field in a single image. Use of aerial vehicles below controlled airspace, allows the aerial vehicle to obtain higher-resolution images than could be obtained at higher altitudes, but low-altitude aerial vehicles are often not capable of capturing an entire agricultural field in a single image. Thus it becomes necessary to obtain a plurality of images of the agricultural field and combine the plurality of images into a single image with a much higher resolution than a single image at high altitude.

### SUMMARY

The present application relates generally to the radiometric calibration and automatic mosaicking of images obtained by aerial vehicles and more particularly, but not by way of limitation, to methods and apparatuses for radiometric calibration and automatic mosaicking utilizing objects of known reflectance positioned around an area to be imaged. In one aspect, the present invention relates to a system for performing radiometric calibration and mosaicking of images. The system includes a calibration reference positioned about an area to be imaged. A sensor is disposed on an aerial vehicle in flight over the area to be imaged. A processor is in communication with the sensor. A plurality of images are obtained by the sensor and are transmitted to the processor. The processor automatically mosaicks and radiometrically calibrates the images after all images of the area have been obtained by the sensor.

In another aspect, the present invention relates to a method of performing radiometric calibration and mosaicking of images. The method includes identifying an area to be imaged and placing a calibration reference at desired locations within the area. A reflectance of the calibration reference is measured and a location of the calibration reference is measured. A plurality of images of the area to be imaged are obtained. The plurality of images are automatically mosaicked relative to the measured location of the calibration references. The plurality of images are radiometrically calibrated relative to the measured reflectance of the calibration references.

### BRIEF DESCRIPTION OF THE DRAWINGS

A more complete understanding of the method and system of the present invention may be obtained by reference to the following Detailed Description when taken in conjunction with the accompanying drawings wherein:

FIG. 1A is a diagrammatic view of a system for performing remote sensing on an area according to an exemplary embodiment;

FIG. 1B is a perspective view of a calibration reference according to an exemplary embodiment;

FIG. 1C is a plan view of a calibration reference according to an exemplary embodiment;

FIG. 2 is a flow diagram of a process for performing remote sensing on an area according to an exemplary embodiment; and

FIG. 3 is an aerial view of an area illustrating a plurality of images taken thereof and illustrating a calibration reference positioned thereon according to an exemplary embodiment.

### DETAILED DESCRIPTION

Various embodiments of the present invention will now be described more fully with reference to the accompanying drawings. The invention may, however, be embodied in many different forms and should not be construed as limited to the embodiments set forth herein.

In many remote-sensing applications, particularly agricultural applications, it is important to convert image pixel-value data—between 0 and 255 in an 8-bit electronic-measurement system—to reflectance data, which is typically between 0 and 1 as a fraction of reflectance, so that consistent meaningful analyses can be made on the obtained images. Other embodiments may make use of alternative number units such as, for example, 0 to 1023 in a 10-bit system to describe pixel-value data. In a typical embodiment, such analysis may include, for example, calculation of Normalized Difference Vegetation Index (“NDVI”). By way of example, NDVI is a common descriptor of plant health and is obtained through red and near-infrared reflectance.

Measurement of NVDI, as well as other health-indicative parameters, requires correction of pixel-value data to actual reflectance data. In a typical embodiment, reflectance data is a material surface property and is based on the material properties of the crop and not, for example, on illumination conditions, etc. This conversion/correction process is known as radiometric calibration. Radiometric calibration has customarily been done by placing objects of known reflectance (known as calibration references) in the field of view (“FOV”) of a camera or sensor onboard an aircraft or satellite, assuming the area of interest can be included in one image. With the use of unmanned aerial vehicles in agricultural remote sensing, the sensor FOV typically will not encompass a large field due to the low-altitude flight of the aerial vehicle. In fact, several hundred images are often required to cover the field of interest, and these images must be combined together so the field can be visualized and analyzed in a comprehensive manner. This process is known as “mosaicking.” In this situation, conventional methods of radiometric calibration are not feasible, as it is practically impossible to place a calibration reference in view of every aerial vehicle sensor-imaging position.

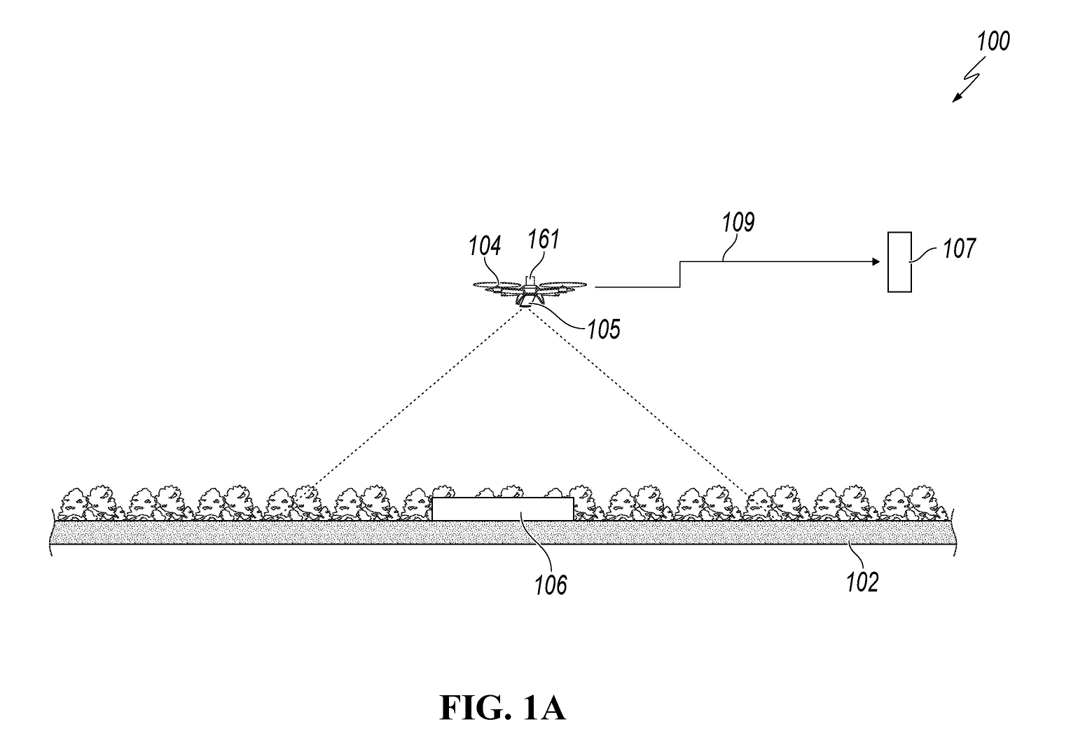

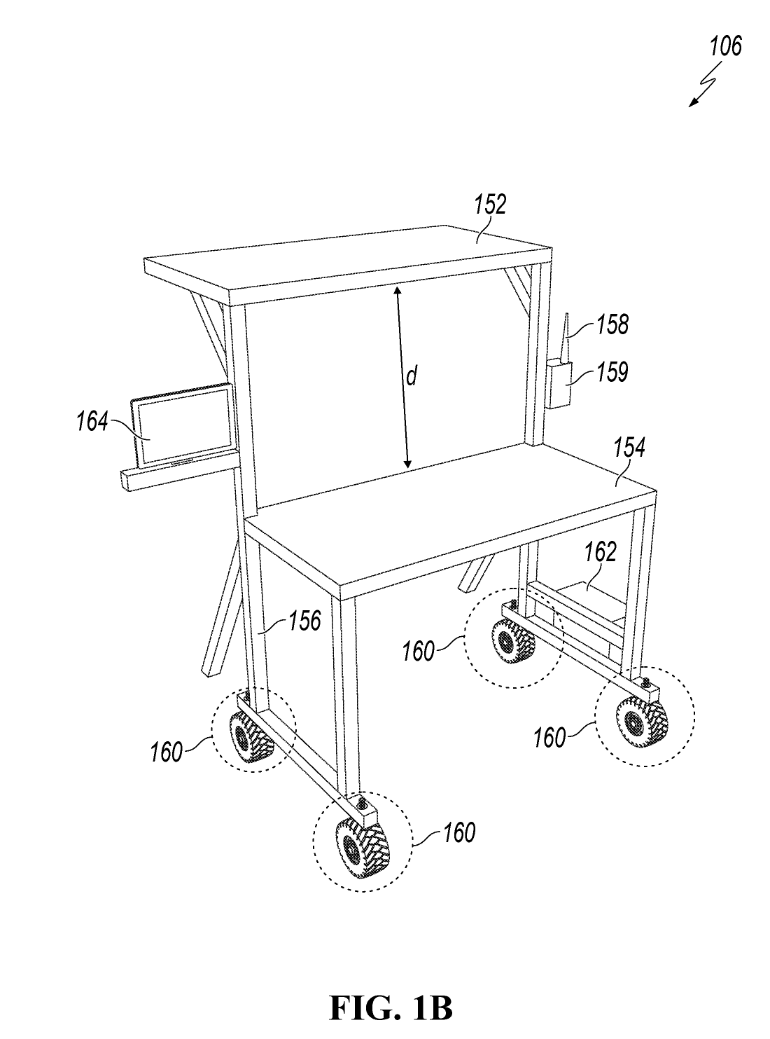

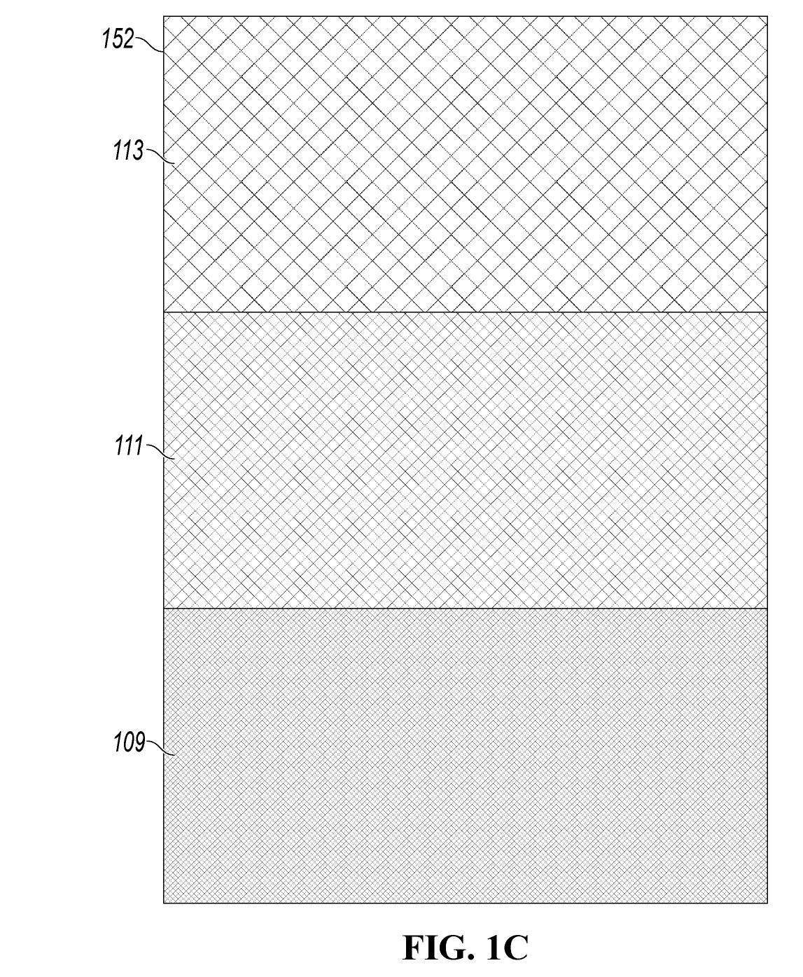

FIG. 1A is a diagrammatic view of a system 100 for performing remote sensing on an area 102. The system 100 includes an aerial vehicle 104 that traverses the space above the area 102 in low-altitude flight. In various embodiments, the aerial vehicle may be a manned vehicle or an unmanned aerial vehicle (“UAV”) or any other type of vehicle such as, for example, a blimp or balloon. In various embodiments, the aerial vehicle may be either tethered or untethered. The aerial vehicle 104 is equipped with a sensor 105. In a typical embodiment, the sensor 105 is capable of measuring reflectance in bands of the visible and near-infrared region of the electromagnetic spectrum; however, in other embodiments, different wavelengths may be captured by the sensor 105 such as, for example, infra-red, ultraviolet, thermal, and other wavelengths as dictated by design and application requirements. The sensor 105 is in communication with a processor 107 that is capable of performing automatic mosaicking and radiometric calibration of images obtained by the sensor 105 after all images of the area 102 have been obtained. Communication between the aerial vehicle 104 and the processor 107 is illustrated graphically in FIG. 1A by arrow 109. In a typical embodiment, the obtained images are transferred to the processor 107 after the aerial vehicle 104 has completed its flight and all images of the area 102 have been obtained; however, in other embodiments, the obtained images may be transferred to the processor 107 during flight. In various embodiments, the aerial vehicle 104 can be either a fixed-wing aircraft or a rotary-wing aircraft; however, use of rotary-wing aircraft enables multi-directional flight and the ability to hover over the area 102, if desired. In a typical embodiment, the area 102 is an agricultural field; however, in other embodiments, the area 102 could be any area where aerial remote sensing could be performed. The aerial vehicle 104 includes a real-time kinematic (“RTK”) global-positioning system (“GPS”) receiver 161. During operation the receiver 161 determines position information of the aerial vehicle 104 and transmits the position information 104 to the processor 107.

Still referring to FIG. 1A, calibration references 106 are placed at various positions in the area 102. In a typical embodiment, the calibration references 106 are constructed from materials of known surface reflectance. In other embodiments, the calibration references 106 are mobile and capable of being moved to a variety of locations in the area 102. The calibration references 106 are, in a typical embodiment, positioned at convenient, representative, and precisely-measured locations in the area 102 thereby allowing the calibration references 106 to be used as ground control points for geographic registration and mosaicking as well as references for radiometric calibration. In a various embodiments, the calibration references 106 are, for example, concrete tiles or rubber matting. The calibration references 106 are painted with flat paint to provide a range of reflectances within a dynamic range of the sensor 105. The calibration references 106 are placed at multiple locations throughout the area 102 that provide a geographic representation of the area to be mosaicked and that are also in convenient locations for maintenance and that do not interfere with farm operations.

Still referring to FIG. 1A, the calibration references 106 are placed in groups having low to high reflectances within the dynamic range of the sensor 105. In a typical embodiment, a position of the calibration references 106 is measured at the time of placement with a highly accurate and precise system such as, for example, a real-time kinematic (“RTK”) global-positioning system (“GPS”) receiver 159. As will be discussed hereinbelow relative to FIG. 1B, the RTK GPS receiver 159 may be integrated with the calibration reference 106. In various embodiments, the calibration references 106 must be cleaned to remove accumulated soil, vegetation, or other debris before measurements or imaging can occur. In various embodiments, the calibration references 106 include a self-cleaning coating such as, for example, a removable covering. The self-cleaning coating is resistant to, for example, weather, and exposure to ultra-violet radiation. When aerial vehicle 104 images are to be collected over the area 102, the calibration references 106 should be cleaned and measured for reflectance with a device such as, for example, a handheld spectrophotometer. Reflectance data obtained from the calibration references are then used to develop factors to convert pixel values to reflectance. In certain embodiments, a three-dimensional surface function is utilized to account for the expected relationship between conversion factor and position in the mosaic.

FIG. 1B is a perspective view of a calibration reference 106. The calibration reference 106 includes an upper calibration target 152 and a lower calibration target 154. The upper calibration target 152 and the lower calibration target 154 are mounted in a frame 156 and are vertically displaced from each other by a known distance (d). Vertical displacement of the upper calibration target 152 from the lower calibration target 154 allows calibration of height by the processor 107 from images obtained by the sensor 105. Calibration of height allows measurement, for example, of crop height by the processor 107. In this manner, the processor 107 determines a three-dimensional model of the area 102. The calibration reference 106 is equipped with a real-time kinematic (“RTK”) global-positioning system (“GPS”) receiver 159. During operation, the RTK GPS receiver 159 receives position information of the calibration reference 106. An antenna 158 is coupled to the RTK GPS receiver 159. In operation, the antenna 158 transmits, for example global-positioning (“GPS”) information of the calibration reference 106 to, for example the processor 107.

Still referring to FIG. 1B, in various embodiments, the calibration reference 106 includes wheels 160 that are mounted to the frame 156. The wheels 160 are driven by a motor 162 that is electrically coupled to a controller 164. The controller 164 is coupled to the antenna 158. In operation, the antenna 158 receives, for example, information from the aerial vehicle 104 related to, for example, a desired position of the calibration reference 106. Upon receipt of the desired position information, the controller 164 directs the wheels 160 to drive the calibration reference 106 to a desired location in the area 102.

FIG. 1C is a plan view of a calibration target such as, for example, the upper calibration target 152 or the lower calibration target 154. For purposes of illustration, FIG. 1C will be discussed herein relative to the upper calibration target 152; however, one skilled in the art will recognize that the lower calibration target 154 is arranged similar to the upper calibration target 152. A first third 109 of the calibration target 152 is painted black (approximately 10% reflectance), a second third 111 of the calibration target 152 is painted dark gray (approximately 20% reflectance), and a last third 113 of the calibration target 152 is painted light gray (approximately 40% reflectance). The size of the calibration target 152 is selected such that the calibration targets (152, 154) are clearly distinguishable from items and materials appearing in the background such as, for example, crops or other vegetation. In various embodiments, the calibration targets (152, 154) comprise, for example, 61 cm×61 cm concrete tiles; however, in other embodiments, other sizes and materials such as, for example, acrylic, various plastics, or fabrics could be utilized as dictated by design requirements. In various embodiments, at least one calibration reference 106 could be an object of known reflectance within the area 102 such as, for example, a building, a road, or another structure in a permanent location.

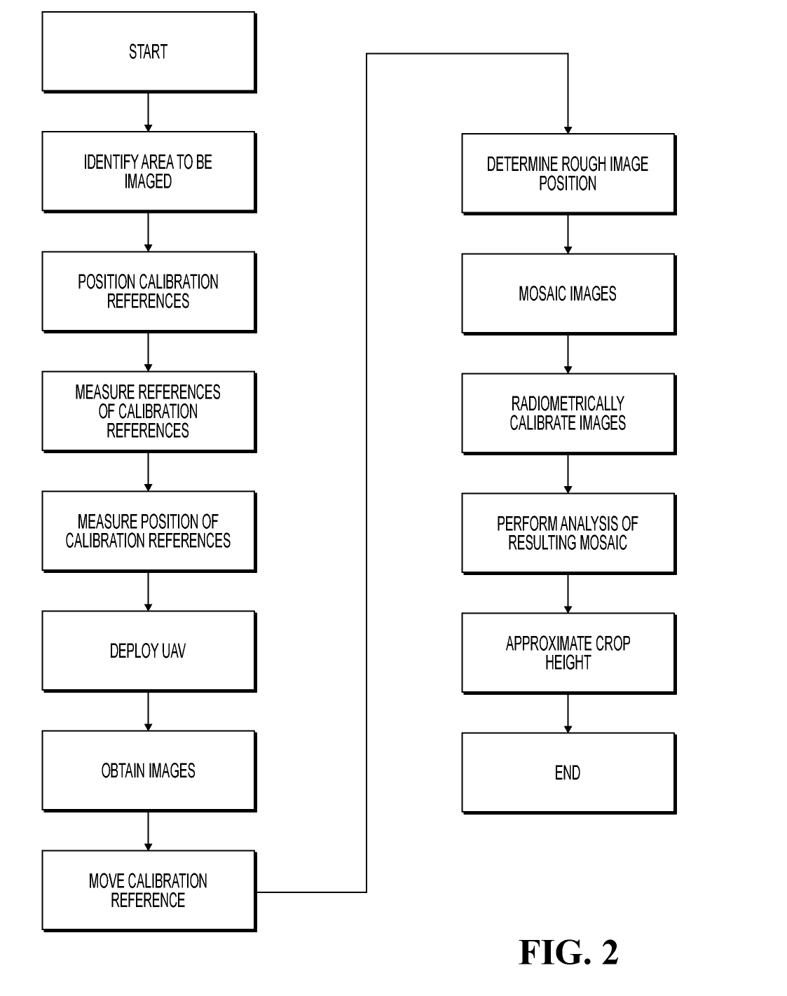

FIG. 2 is a flow diagram of a process 200 for performing remote sensing on an area. For purposes of discussion, FIG. 2 will be discussed herein relative to FIG. 1. The process 200 begins at step 202. At step 204 an area 102 to be imaged is identified. At step 205, a calibration reference 106 is positioned at desired locations in the area 102. At step 206, the reflectances of the calibration references 106 are measured. At step 208, a position of the calibration references 106 is recorded using, for example, the RTK GPS receiver 159. The position of the calibration references 106 is transmitted to the processor 107 via the antenna 158. At step 210, an aerial vehicle 104 having a sensor 105 is deployed to traverse the area 102. The processor 107 receives position information from the aerial vehicle 107 during the flight of the aerial vehicle. In a typical embodiment, the aerial vehicle 104 makes multiple passes over the area 102 while in low-altitude flight. At step 212, a plurality of images of the area 102 are obtained by the sensor. At step 213, the processor 107 directs the calibration reference 106 to move to a second location.

Still referring to FIG. 2, at step 214, a position of each image of the plurality of images is obtained relative to the position of calibration references 106. At step 215, a rough position of each image relative to the other images is determined using, for example, GPS and IMU information from the aerial vehicle 104. At step 216, the calibration references 106 are identified in the plurality of images and the plurality of images are mosaicked into a single image. At step 218, the plurality of images are radiometrically calibrated against the calibration references 106. At step 220, analysis of, for example, reflectance data is performed on the single image. In a typical embodiment, steps 214-220 are performed by the processor 107 after all images of the area 102 have been obtained. At step 221, a crop height is approximated utilizing a difference in height measured between the upper calibration target 152 and the lower calibration target 154. The process 200 ends at step 222.

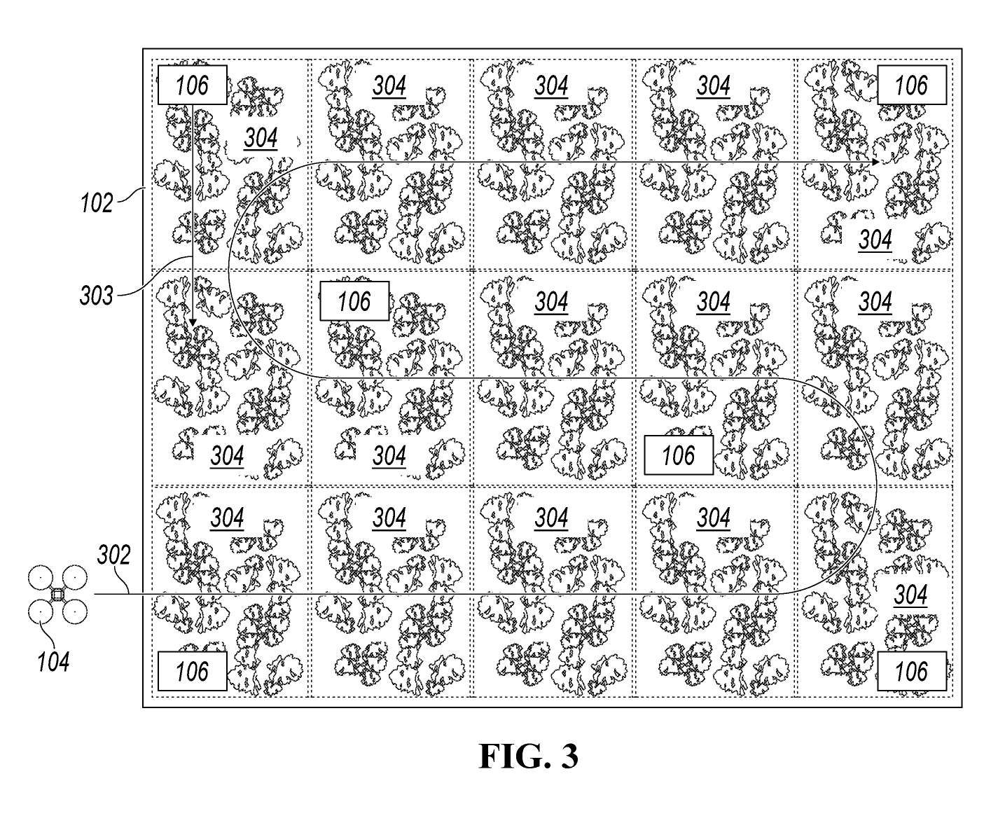

FIG. 3 is an aerial view of the area 102 illustrating a plurality of images 304 taken thereof and illustrating a calibration reference 106 positioned thereon. For purposes of discussion, FIG. 3 will be discussed herein relative to FIGS. 1 and 2. In a typical embodiment, the aerial vehicle 104 is deployed to traverse a distance above the area 102 in low-altitude flight. By way of example, FIG. 3 illustrates a flight path 302 of the aerial vehicle as having an out-and-back pattern; however, in other embodiments, the flight path 302 could assume any appropriate pattern as necessitated by design requirements. During flight, the sensor 105 disposed on the aerial vehicle 104 obtains a plurality of images (illustrated diagrammatically as 304) of the area 102. In a typical embodiment, the images 304 are obtained sequentially; however, in other embodiments, the images 304 may be obtained in any order. As illustrated in FIG. 3, in a typical embodiment adjacent images 304 overlap to ensure complete coverage of the area 102 and to ensure that the object height calculations can be made. In a typical embodiment, the images 304 are analyzed by the processor 107 to determine a need to re-visit various portions of the area 102. Such analysis minimizes the possibility of a poor mosaic being produced due to inadequate overlap of the images 304. After a sufficient number of images 304 have been obtained to image the area 102, the images 304 are transmitted to the processor 107 to be automatically mosaicked and radiometrically calibrated. As discussed above, transmission of the images 304 to the processor 107 typically occurs after the aerial vehicle 104 has completed its flight; however, in other embodiments, the images 304 may be transmitted to the processor 107 during flight.

Still referring to FIG. 3, the calibration references 106 are illustrated by way of example as being disposed proximate to a periphery of the area 102. In various other embodiments, the calibration references 106 may be disposed at any location within the area 102. The calibration references 106 are disposed in areas that are easily accessible for maintenance and reflectance measurement. As illustrated in FIG. 3, a calibration reference 106 is not present in every image 304 obtained by the sensor 105. Thus, in a typical embodiment, calibration data obtained from the calibration references 106 must be extrapolated to each of the plurality of images 304 even if a calibration reference 106 is not present in a particular image 304.

Still referring to FIG. 3, as noted above, a location of the calibration references 106 is precisely measured utilizing, for example, the RTK GPS receiver 159. In a typical embodiment, as the plurality of images 304 are obtained by the sensor 105, a location of the particular image, as determined by the RTK GPS receiver 159 is recorded relative to one or more calibration references 106. In a typical embodiment, the location of the particular image is utilized during mosaicking of the plurality of images 304 to ensure that each image of the plurality of images 304 is correctly and accurately placed. Thus, the calibration references 106 serve a dual purpose as both a reference point for radiometric calibration and a ground control point for geolocation of the plurality of images 304. Additionally, the location information of each image of the plurality of images 304 facilitates determination of whether adequate overlap exists between various images of the plurality of images 304 such that the entire area 102 is imaged in the mosaic. In situations where adequate overlap does not exist, the aerial vehicle 104 may be directed to return to a specified portion of the area 102 to obtain further images before mosaicking and radiometric calibration are performed. In situations where mobile calibration references 106 are utilized, the calibration references 106 are directed by the processor 107 to subsequent locations after initial placement in the area 102. Movement of the calibration sensors 106 is illustrated in FIG. 3 by arrow 303.

Although various embodiments of the method and system of the present invention have been illustrated in the accompanying Drawings and described in the foregoing Specification, it will be understood that the invention is not limited to the embodiments disclosed, but is capable of numerous rearrangements, modifications, and substitutions without departing from the spirit and scope of the invention as set forth herein. For example, although the area 102 has been described herein as being an agricultural field, one skilled in the art will recognized that the area 102 could be any geographic area on which remote sensing could be performed. It is intended that the Specification and examples be considered as illustrative only.

What is claimed is:

1. A system for performing radiometric calibration and mosaicking of images, the system comprising:
a calibration reference positioned about an area to be imaged;
a sensor disposed on an aerial vehicle in flight over the area to be imaged;
a processor in communication with the sensor; and
wherein a plurality of images obtained by the sensor and transmitted to the processor; and
wherein the processor automatically mosaicks and radiometrically calibrates the images obtained by the sensor.

2. The system of claim 1, wherein the aerial vehicle is manned.

3. The system of claim 1, wherein the aerial vehicle is an unmanned aerial vehicle.

4. The system of claim 1, wherein the calibration reference is mobile.

5. The system of claim 1, wherein the calibration reference comprises a self-cleaning coating.

6. The system of claim 1, wherein the calibration reference comprises an upper calibration target and a lower calibration target.

7. The system of claim 1, wherein the sensor comprises a camera.

8. The system of claim 1, wherein aerial vehicle comprises a global positioning (“GPS”) receiver.

9. The system of claim 1, wherein the sensor is configured to measure reflectance in the visible and near infra-red spectrums.

10. The system of claim 1, wherein the sensor is configured to detect thermal energy.

11. A system for performing radiometric calibration and mosaicking of images, the system comprising:
a mobile calibration reference positioned about an area to be imaged;
a sensor disposed on an unmanned aerial vehicle in flight over the area to be imaged;
a processor in communication with the sensor; and
wherein a plurality of images obtained by the sensor and transmitted to the processor; and
wherein the processor automatically mosaicks and radiometrically calibrates the images obtained by the sensor.

12. The system of claim 1, wherein the calibration reference comprises a self-cleaning coating.

13. The system of claim 1, wherein the calibration reference comprises an upper calibration target and a lower calibration target.

14. The system of claim 1, wherein the sensor comprises a camera.

15. The system of claim 1, wherein aerial vehicle comprises a global positioning (“GPS”) sensor and an inertial measurement (“IMU”) sensor.

16. The system of claim 1, wherein the sensor is configured to measure reflectance in the visible and near infra-red spectrums.

17. The system of claim 1, wherein the sensor is configured to detect thermal energy.

18. A method of performing radiometric calibration and mosaicking of images, the method comprising:
identifying an area to be imaged;
placing a calibration reference at desired locations within the area;
measuring a reflectance of the calibration reference via a sensor disposed on an aerial vehicle;
measuring a location of the calibration reference via the sensor disposed on the aerial vehicle;
obtaining a plurality of images of the area to be imaged;
mosaicking the plurality of images relative to the measured location of the calibration references; and
radiometrically calibrating the plurality of images relative to the measured reflectance of the calibration references.

19. The method of claim 18, wherein the measuring a location of the calibration reference comprises measuring a height of the calibration reference.

20. The method of claim 18, comprising determining a height of vegetation present in the area.
